(19) United States
(12) Patent Application Publication
(10) Pub. No.: US 2012/0216050 A1
(43) Pub. Date: Aug. 23, 2012

(54) MICROCODE AUTHENTICATION

(75) Inventors: Craig Barner, Shrewsbury, MA (US); David Carlson, Haslet, TX (US)

(73) Assignee: Cavium, Inc., San Jose, CA (US)

(21) Appl. No.: 13/403,360

(22) Filed: Feb. 23, 2012

Related U.S. Application Data
(60) Provisional application No. 61/445,681, filed on Feb. 23, 2011.

(51) Int. Cl. G06F 21/00

(52) U.S. Cl. 713/189

(57) ABSTRACT

A microcode authentication unit provides access to a secure hardware unit. A microcode segment is provided to the microcode authentication unit, which generates a signature corresponding to the segment and compares the size and signature of the segment against stored values. If a match is determined, the unit enables access to the secure hardware unit.

### RELATED APPLICATION

This application claims the benefit of U.S. Provisional Application No. 61/445,681, filed on Feb. 23, 2011. The entire teachings of the above application are incorporated herein by reference.

### BACKGROUND

High-bandwidth Digital Content Protection (HDCP) is a form of copy protection for digital media. It is typically implemented in media sources (e.g., set-top boxes, DVD player), media sinks (e.g., televisions, digital projectors), and repeaters (e.g., home theater receivers), and provides an encrypted data transmission between devices to prevent copying of digital audio and video content. The High-Definition Multimedia Interface (HDMI) interface, in particular, employs HDCP encryption.

In order to access HDCP-encrypted media, a device must be authenticated. During a typical authentication process, a pair of linked devices exchange respective public keys. Each device generates a number by processing a respective secret key according to the received public key. A device is then authenticated by comparing the generated number against the number provided by the linked device. If there is a match between the numbers, then the device is authenticated and the respective link is determined to be secure, enabling the device to access the encrypted media. If authentication fails due to a mismatch of the numbers, then the device is prohibited from accessing the protected content.

### SUMMARY OF THE INVENTION

Example embodiments of the present invention provide a method and apparatus for authenticating and controlling access to privileged hardware. A microcode authentication unit receives a microcode segment and generates a corresponding signature resulting from a hash function. The signature and size of the microcode segment are compared against predetermined stored values. If a match is determined, the authentication unit enables access to protected hardware units within the device.

In an example embodiment, a method of controlling access to hardware features includes generating a signature corresponding to a received microcode segment, and comparing the signature against a stored signature value. If a match is detected between the signature and the stored signature value, access to a secure hardware unit is enabled. In further embodiments, a dimension of the microcode segment can be compared against a stored size value. Generating the signature may include executing a SHA-1 hash function of the microcode segment, the signature being a SHA-1 hash value. The secure hardware unit may include a device storing an AES secure key or an encrypted HDCP key.

In further embodiments, a circuit for controlling access to hardware features includes a secure hardware unit, a storage unit storing a stored signature value, and a microcode authentication unit. The microcode authentication unit may be configured to generate a signature corresponding to a received microcode segment, compare the signature against a stored signature value, and enable access to the secure hardware unit in response to a match between the signature and the stored signature value.

In still further embodiments, one or more fuse circuits may provide the stored signature value. A stored size value may be provided from the fuse circuit, and a dimension of the microcode segment may be compared against the stored size value. The fuse circuit may be permanently blown to indicate the stored signature value. The fuse circuit may be fixed to the protected hardware unit, which may render it inaccessible to outside access and therefore not susceptible to interception or modification. If an absence of a match between the signature and the stored signature value is detected, access to the secure hardware unit can be prevented, while access to an execution unit independent of the secure hardware unit can be enabled regardless of whether a match is detected.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of a pair of linked HDMI devices in which embodiments of the present invention may be implemented.

FIG. 2 is a block diagram of a computer hardware assembly for authenticating a received microcode segment.

FIG. 3 is a flow diagram of a process of authenticating a microcode segment that may be completed by the assembly in FIG. 2.

FIG. 4 is a block diagram of a computer hardware assembly for authenticating a received microcode segment, coupled to a host controller that is not authenticated.

### DETAILED DESCRIPTION OF THE INVENTION

A description of example embodiments of the invention follows. Embodiments of the present invention provide a method and apparatus for authenticating and controlling access to privileged hardware.

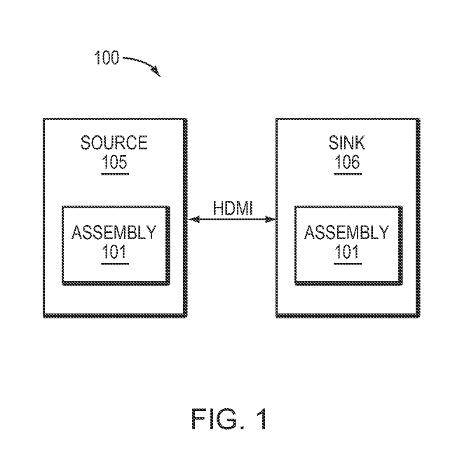

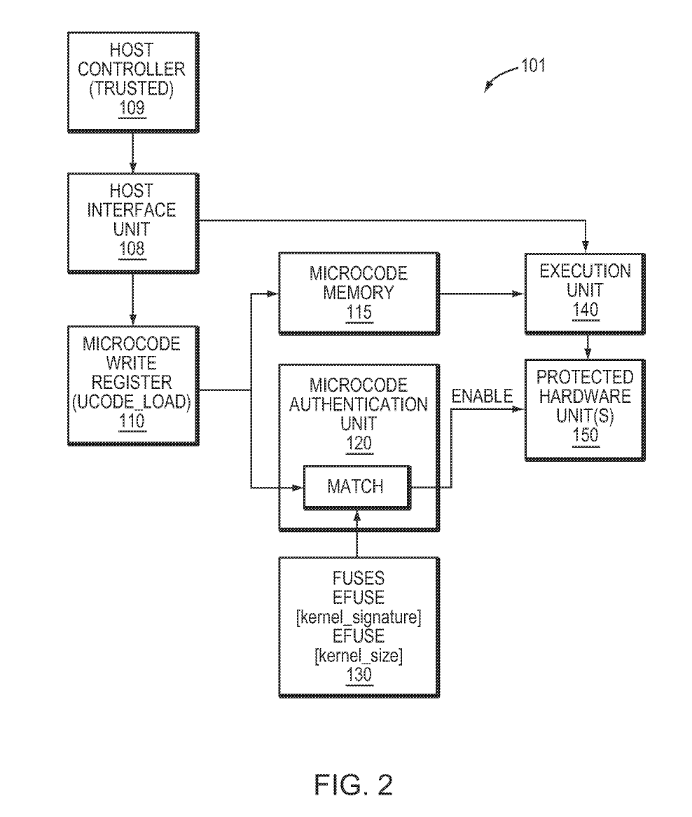

FIG. 1 is a block diagram illustrating a system 100 comprising a pair of linked HDCP devices. A source 105 is a device configured to output HDCP-protected media content (e.g., a set-top box, DVD player), and is connected via an HDMI link to a sink 106, which is a device configured to convey received HDCP-protected media in an audio/video format (e.g., a television, digital projectors). Both the source 105 and sink 106 include an assembly 101 configured to maintain a Device Secret Key, which is used to decrypt the HDCP-encrypted content. The assembly 101 may include a combination of hardware and/or software components, such as a CPU, ASIC or other architecture, and is described in further detail below with reference to FIG. 2.

For an HDCP transmitter (source), a Device Secret Key consists of a secret global constant (128 bits). For an HDCP receiver (sink), Device Secret Keys consists of the secret global constant and the Digital Content Protection, LLC (DCP)/Rivest,

Shamir and Adleman (RSA) private key (128 bits+1024 bits). The Device Secret Keys must be protected from exposure outside of the HDCP Device. To prevent such exposure, the Device Secret Keys are encrypted using an Advanced Encryption Standard (AES) secure key and stored either into fuses (ie. efuse[secret_keys]) or into external flash. In the latter case, the efuses contain other secret keys to protect the Device Secret Keys. Microcode comprises instructions for controlling various hardware and software components within the devices, and may implement the desired protection scheme (RSA, ECC, etc.), as determined by the respective device. The microcode is provided by a host controller. To prevent malicious microcode from exposing the Device Secret Keys, only authenticated microcode may access the efuse[secret_keys] or the AES secure key required to decrypt efuse[secret_keys].

The AES secure key (SKEY) can only be accessed in secure mode, which is enabled upon authenticating the received microcode. The secure key is accessed by writing to AES_SKEY register instead of AES_KEY register. A write to AES_SKEY while in secure mode will replace the write data with the secure key. When not in secure mode, AES_SKEY is just a synonym for AES_KEY. As a result, the actual write data will be used instead of the secure key.

Microcode cannot read the secure key or the secure key schedule, even in secure mode. Only the AES unit has access, and only in secure mode. As before, the AES backing store shares some addresses with the AES key and AES key schedule. Consequently, reads to the shared addresses will return zeros while the secure key or secure key schedule is loaded. The only way to clear out the secure key is to write another key to AES_KEY and then create a new key schedule by writing to any of AES_DATA_.

Microcode authentication is performed by the “microcode authentication unit” hardware, described below with reference to FIG. 2. This microcode authentication unit performs a Secure Hash Algorithm-1 (SHA-1) hash operation as the microcode is loaded into the program memory via writes to the UCODE_LOAD register performed by the host controller. The microcode load is performed sequentially, starting from program memory address zero. For each instruction loaded by the host controller, the microcode authentication unit adds the instruction's “address/instruction/parity” to the hash. Fuses provide the authorized microcode size (ie. efuse[kernal_size]) and the authorized microcode digest (ie. efuse[kernal_signature]) to the microcode authentication unit. When the final instruction is loaded (as per efuse[kernel_size]), the computed microcode digest value gets compared to authorized microcode digest (ie. efuse[kernel_signature]). If they match, the microcode has been authenticated. Once authenticated, the UCODE_LOAD register is disabled to prevent further loading. Additionally, the authenticated microcode may now access privileged hardware features, such as the efuse[secret_keys] and the AES secure key required to decrypt efuse[secret_keys]. Microcode that has not been authenticated may not access privileged hardware features, such as the efuse[secret_keys] and the AES secure key required to decrypt efuse[secret_keys].

If no fuses have been blown, then efuse[kernel_size]=0. In this case, no microcode will be granted access to the privileged hardware features.

A device may exit the secure mode by performing a reset of the execution unit. A reset clears the register file, cpu/aux registers, FV, accumulator, etc.

The kernel microcode can be either a small bootstrap microcode that supports loading secure images (i.e., RSA signature verification support must be included in the bootstrap image), or it can be a full featured microcode with complete feature set to support HDCP2.0, etc.

If desired, the kernel microcode may allow loading of secure microcode images. In order for the secure images to be loaded, they must be signed with a private key (at microcode image generation time) and successfully verified with a public key (at microcode load time). Only images whose digital signature is successfully verified can be loaded in the secure mode (a kernel software feature).

FIG. 2 illustrates a computer hardware assembly 101 in which embodiments of the present invention may be implemented. The assembly 101, a microcode authentication circuit, may be configured in a device such as an HDCP source or repeater, which in turn may be coupled to one or more additional HDCP devices. A microcode write register 110 stores a received microcode segment provided by the host controller 109 (e.g., a code provided by the respective device to control hardware operations), and formats the microcode segment for loading at the microcode memory 115 and the microcode authentication unit 120.

The microcode authentication unit 120 processes the microcode segment to generate a signature. Fuses 130 store one or more values for comparing against the microcode segment or the generated signature. The microcode memory 115 maintains the microcode for execution by an execution unit 140, which may include a processor to carry out hardware operations according to the microcode instructions. The execution unit may have access to additional hardware units (not shown) present in the respective device. If the microcode is authorized by the microcode authentication unit 120, the execution unit 140 will have access to protected hardware units 150, which may include keys such as an AES secure key. The protected hardware units may further include any other hardware components, functions or information (e.g., keys, privileged or encrypted data) that are to be protected from access by unauthorized microcode.

The assembly 101 may be implemented in a single integrated circuit, or as a plurality of chips enclosed in a system-in-package (SiP) embodiment. Implementing the fuses 130 within the chip may provide additional security in authenticating the microcode. In particular, by providing the predetermined values for authentication (stored in the fuses) within the chip, rather than loading the values onto the chip, the assembly is not susceptible to receiving incorrect values from an external source, which could result in incorrectly authenticated microcode.

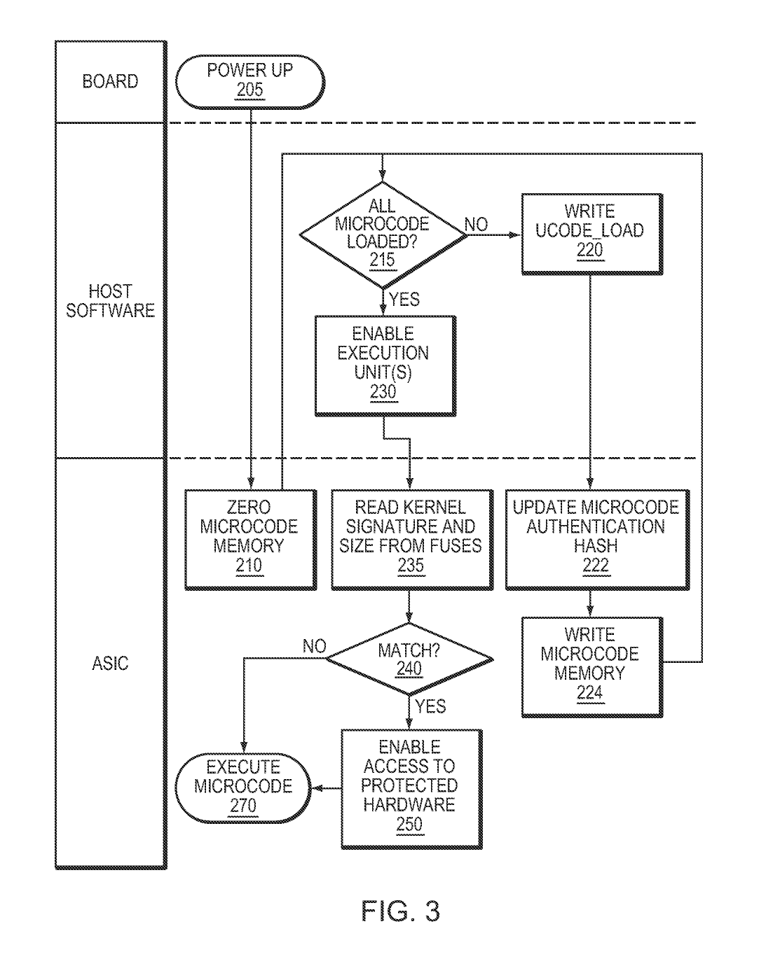

An example operation of the assembly 101 is described below with reference to FIG. 3.

FIG. 3 is a flow diagram of a process of authenticating a microcode segment for access to protected hardware. With reference to FIG. 1, upon powerup of the assembly 101 (205), the microcode memory 115 is cleared (210) to prevent execution of previously loaded microcode. The host controller 109 may be configured to load a microcode segment automatically upon startup. The host controller 109 writes each instruction to the UCODE LOAD register 110 until all instructions of the microcode segment have been written (215). Each instruction written to the UCODE LOAD register 110 (220) is forwarded to both the microcode authentication unit 120 and the microcode memory 115 (224). Once the microcode is loaded into the authentication unit 120, the authentication unit 120 generates a signature of the microcode segment (222) and locks the UCODE LOAD register. The signature may be generated by performing one or more algorithmic functions on the microcode segment, such as a hash function (e.g., an SHA-1 hash function).

Once the microcode is loaded at the memory 115 and the authentication unit 120 (215), the execution unit 140 is enabled (230) to carry out hardware operations as instructed by the microcode in response to requests made by the host controller 109. The authentication unit 120 accesses the fuses 130 to read one or more codes corresponding to characteristics of the microcode or the generated signature (235). For example, the fuses 130 may specify a predetermined signature that corresponds to (or matches) the signature generated from an authorized microcode segment (“Efuse[kernel_signature]”), as well as specify a size of the microcode segment to be authenticated (“Efuse[kernel_size]”).

The authentication unit 120 then compares the loaded microcode size and generated signature against the predetermined values stored at the fuses 130 (240). The authentication unit 120 may compare a subset of the generated signature (rather than the entire signature) against the predetermined value. For example, if the signature is generated by an SHA-1 hash and is 160 bits in size, a 64-bit subset of the signature may be selected for the comparison. If the values match, then the authentication unit 120 enables access to the protected hardware units 150 (250). The execution unit 140 proceeds to execute the microcode (270), and may access the protected hardware units 150 as required by the microcode. If a match fails (240), then access to the protected hardware units 150 remains disabled, and the execution unit 140 proceeds to execute the microcode without accessing the protected hardware units 150.

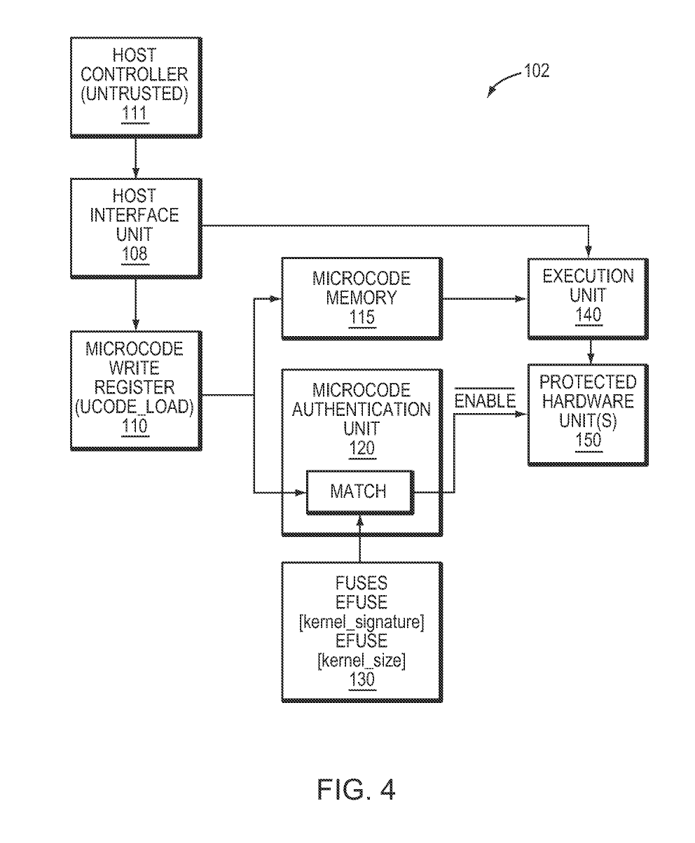

FIG. 4 is a block diagram of a computer hardware assembly 102, configured in a manner comparable to the assembly 101 described above with reference to FIG. 2, yet is coupled to a host controller 111 that fails to be authenticated. The assembly may perform the process of authenticating a microcode segment for access to protected hardware described above with reference to FIG. 3. However, because the host controller 111 fails to provide authentic microcode for accessing the protected hardware units 150, the microcode authentication unit 120 determines that the signature generated from the microcode segment fails to match the predetermined values provided by the fuses 130 (240, FIG. 3). As a result, the host controller 111 proceeds to access the execution unit 140 to execute the microcode (270), but is prohibited from accessing the protected hardware units 150.

Additional information regarding HDCP procedures and authentication are described in U.S. patent application Ser. No. 12/848184 and U.S. Provisional Application 61/326546, the teachings of which are incorporated by reference. The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method of controlling access to hardware features, comprising:
generating a signature corresponding to a received microcode segment;
comparing the signature against a stored signature value; and
enabling access to a secure hardware unit in response to a match between the signature and the stored signature value.

2. The method of claim 1, further comprising:
comparing a dimension of the microcode segment against a stored size value.

3. The method of claim 1, wherein generating the signature includes executing a SHA-1 hash function of the microcode segment, the signature being a SHA-1 hash value.

4. The method of claim 1, wherein the secure hardware unit includes a device storing an AES secure key.

5. The method of claim 1, wherein the secure hardware unit includes a device storing an encrypted HDCP key.

6. The method of claim 1, further comprising providing the stored signature value from at least one fuse circuit.

7. The method of claim 6, further comprising:
providing a stored size value from the at least one fuse circuit; and
comparing a dimension of the microcode segment against the stored size value.

8. The method of claim 6, wherein providing the stored signature value includes permanently blowing the at least one fuse circuit to indicate the stored signature value.

9. The method of claim 6, wherein at least one fuse circuit is fixed to the protected hardware unit.

10. The method of claim 1, further comprising, in response to detecting an absence of a match between the signature and the stored signature value:
preventing access to the secure hardware unit.

11. The method of claim 10, further comprising enabling access to an execution unit independent of the secure hardware unit.

12. A circuit for controlling access to hardware features, comprising:
a secure hardware unit;
a storage unit storing a stored signature value; and
a microcode authentication unit configured to generate a signature corresponding to a received microcode segment, compare the signature against a stored signature value, and enable access to the secure hardware unit in response to a match between the signature and the stored signature value.

13. The circuit of claim 12, wherein the microcode authentication unit is further configured to compare a dimension of the microcode segment against a stored size value.

14. The circuit of claim 12, wherein the microcode authentication unit is further configured to execute a SHA-1 hash function of the microcode segment, the signature being a SHA-1 hash value.

15. The circuit of claim 12, wherein the secure hardware unit includes a device storing an AES secure key.

16. The circuit of claim 12, wherein the secure hardware unit includes a device storing an encrypted HDCP key.

17. The circuit of claim 12, wherein the storage unit includes at least one fuse circuit.

18. The circuit of claim 17, wherein the storage unit is configured to provide a stored size value from the at least one fuse circuit, the microcode authentication unit comparing a dimension of the microcode segment against the stored size value.

19. The circuit of claim 17, wherein the at least one fuse circuit is permanently blown to indicate the stored signature value.

20. The circuit of claim 17, wherein at least one fuse circuit is fixed to the protected hardware unit.

21. The circuit of claim 1, wherein the microcode authentication unit, in response to detecting an absence of a match between the signature and the stored signature value, prevents access to the secure hardware unit.

22. The circuit of claim 21, wherein the microcode authentication unit enables access to an execution unit independent of the secure hardware unit.
